(19) United States
(12) Patent Application Publication
(10) Pub. No.: US 2005/0030318 A1
(43) Pub. Date: Feb. 10, 2005

(54) Data processing apparatus and method for changing screen theme

(75) Inventor: Takeyuki Ueda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/795,276

(22) Filed: Mar. 9, 2004

(30) Foreign Application Priority Data
Aug. 5, 2003 (JP) 2003-287048

(51) Int. Cl. G09G 5/02; G09G 5/00

(52) U.S. Cl. 345/589

(57) ABSTRACT

A distance between colors of two color attributes out of color attributes of screen parts included in a screen theme definition file inputted into a data processing apparatus, which are adjacent to each other when the screen parts are displayed on an operation screen, is checked. In the case that the distance between colors is smaller than a threshold, use of the screen theme definition file is rejected.

### BACKGROUND OF THE INVENTION

1. Field of the Invention

The present invention relates to a data processing apparatus that can change the screen theme of an operation screen and a method of changing the screen theme in such a data processing apparatus.

2. Description of the Related Art

Among conventional personal computers, some computers have a function of expressing the GUI screen comprising of GUI (Graphical User Interface) parts with the wholly unified theme (screen theme) and changing the screen theme (theme function).

Furthermore, as portable terminal devices such as a cellphone, a PHS (Personal Handyphone System), a PDA (Personal Digital Assistant), etc. become increasingly sophisticated, they are requiring functionalities same as those of a personal computer. Hereinafter, an apparatus that includes all the devices such as a personal computer, a portable terminal device, etc. is referred to as a data processing apparatus.

A W-CDMA (Wideband CDMA) terminal that is a cellphone capable of high speed communications, for example, at 384 KBps requires the installation of a sophisticated application program that uses this communication speed. As an application becomes sophisticated, the operationality becomes ineffective and the appearance also becomes poor with the conventional GUI that is operated only by selecting a command from a list. Thereupon, novel ideas to prepare a GUI control (GUI part) such as a tab, a button, a progress bar, etc. that are generally used in a personal computer, etc. on the W-CDMA terminal and also to prepare an application that realizes rich expression using those parts, are executed.

By the way, a cellphone is a product that is used by a broad range of users ranging from youth to corporate executives. Therefore, it is very difficult to offer a screen theme with a single design that suits the tastes of all the users. However, it costs a lot and it is not realistic to offer a cellphone of which the design is changed in accordance with the taste of each user.

With the same application, however, it is possible to offer various kinds of screen themes that have a decorative high-class impression, a mechanical and functional impression, resemblance to stationery, etc. by uniformly changing the color, the presence or absence of a third dimension, the presence or absence of a frame line, etc with regard to a GUI control. In this case, each user may select the one that fits his or her taste from among the offered several screen themes.

As the method of decreasing consumption electric power without deteriorating the conspicuous display screen of a cellphone, there is a method of revising the brightnesses of a background and a character so as to make the average brightness of the background on a screen lower than the average brightness of a character (for example, refer to a patent document 1). Furthermore, there is a method of setting the brightness of a background color lower than the brightness of a character color to avoid a case where the character color and the background color become the same on a screen display device of a cathode-ray tube, etc. so that a character becomes indistinct (for example, refer to a patent document 2).
Patent document 1: Japanese Patent Application Publication No. 2002-199078
Patent document 2: Japanese Patent Application Publication No. 02-224577

However, there is the following problem in the theme function of the above-mentioned cellphone.

There is the possibility that a fraud screen theme is set to a cellphone by a malicious third party in the case where the downloading of the file (screen theme definition file) that defines the various kinds of attributes of a screen theme is permitted for a user to set the screen theme that suits his or her taste.

A fraud screen theme is such a theme that the background color and the character color are the same. Once such a screen theme has been set, a display character, etc. cannot be identified so that the operation of a cellphone cannot be performed. Therefore, the operation of changing to the other screen themes and returning to the original screen theme becomes difficult. Moreover, the setting of the selected screen theme is stored on a nonvolatile memory (flash memory) so that the selected screen theme does not return to the original even if a terminal is reset.

### SUMMARY OF THE INVENTION

The subject of the present invention is to offer a data processing apparatus that does not lose the operationality of a GUI screen even in the case that a fraud screen theme is downloaded as a screen theme that is to be changed by a theme function and a method of changing or switching a screen theme in such a data processing apparatus.

In the first aspect of the present invention, a data processing apparatus is provided with a display device, a check device and a change device. The display device displays an operation screen in accordance with a screen theme. A check device checks a distance between colors of two color attributes, which are adjacent to each other when screen parts are displayed on the operation screen, and which are selected from among color attributes of the screen parts included in an inputted screen theme definition file. The check device further rejects the use of the screen theme definition file in a case where the distance between colors is smaller than a threshold. The change device changes a screen theme of the operation screen to a screen theme designated by the screen theme definition file when the use of the screen theme definition file is not rejected.

In the second aspect of the present invention, a data processing apparatus is provided with a check device and a change device. The check device checks a distance between colors of two color attributes, which are adjacent to each other when screen parts are displayed on the operation screen, and which are selected from among color attributes of the screen parts included in an inputted screen theme definition file. The check device further rejects the use of the screen theme definition file in the case where the distance between colors is smaller than a threshold. The change device changes a screen theme of the operation screen to a screen theme designated by the screen theme definition file when the use of the screen theme definition file is not rejected.

### BRIEF DESCRIPTION OF THE DRAWINGS

FIG. 1 is a block diagram showing the principle of a data processing apparatus of the present invention;

FIG. 2 is a block diagram showing the configuration of a portable terminal device;

FIG. 3 illustrates diagrams showing a GUI control;

FIG. 4 is a table showing a screen theme definition file;

FIG. 5 is a flowchart of a screen theme check processing;

FIG. 6 is a flowchart of a screen theme nullification processing; and

FIG. 7 is a flow chart of a screen theme revision processing.

### DESCRIPTION OF THE PREFERRED EMBODIMENTS

The following is the detailed explanation of the preferred embodiments of the present invention in reference to the drawings.

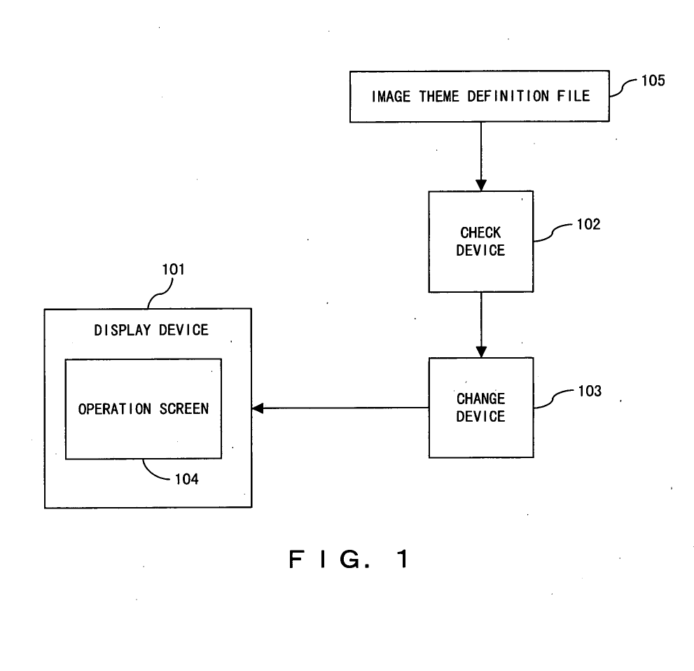

FIG. 1 is a block diagram showing the principle of a data processing apparatus of the present invention. The data processing apparatus of FIG. 1 is provided with a display device 101, a check device 102 and a change device 103. The display device 101 displays an operation screen 104 in accordance with a screen theme. The check device 102 checks the distance between colors of two color attributes that are adjacent to each other and which are selected from among the color attributes of the screen parts included in an inputted screen theme definition file 105, when the screen parts are displayed on the operation screen 104. In the case that the distance between colors is smaller than a threshold, the check device 102 rejects the use of the screen theme definition file 105. Then, the change device 103 changes the screen theme of the operation screen 104 to the screen theme that is designated by the screen theme definition file 105 when the use of the screen theme definition file 105 is not rejected.

When a new screen theme definition file 105 is input from the outside of the data processing apparatus, the check device 102 checks a color attribute of the screen part (for example, a GUI control) that is recorded in the file. If there are two color attributes that are adjacent on the operation screen 104 like a character color and a background color, the distance between colors is calculated using the color information that includes those attribute values. In the case that the distance between colors is smaller than a threshold, the input screen theme definition file 105 is rejected. If the distances among colors of all the adjacent color attributes that are included in the screen theme definition file 105 are equal to or greater than the threshold, the screen theme definition file 105 is not rejected, so that the screen theme of the operation screen 104 is changed to a new screen theme.

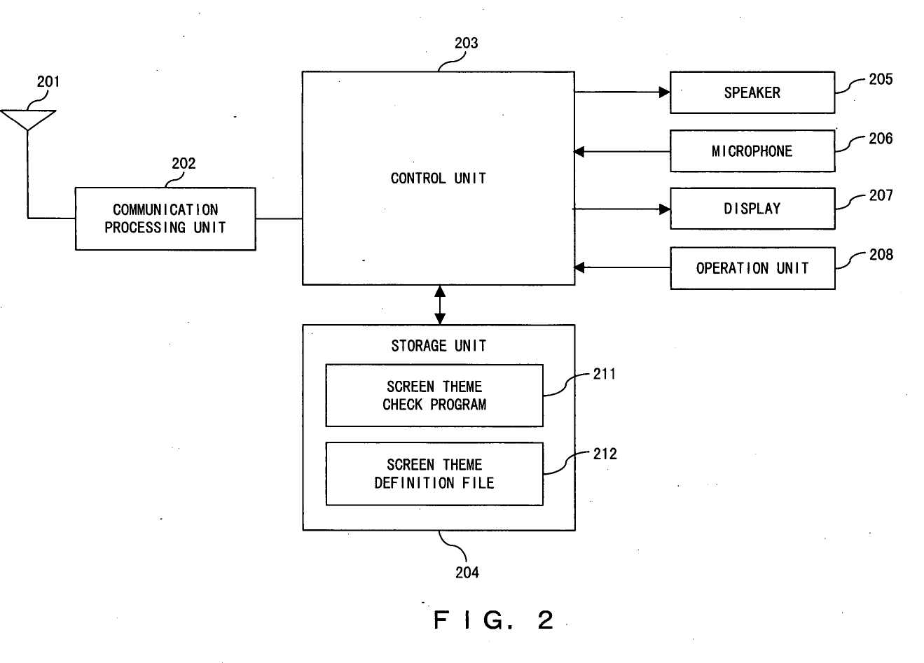

The display device 101 corresponds to, for example, a display 207 of FIG. 2 that is described later while the check device 102 and the change device 103 correspond to, for example, a control unit 203 of FIG. 2.

According to the present invention, a screen theme definition file that includes adjacent color attributes like a character color and a background color and as well has an extremely small distance between colors is rejected and accordingly the file is not reflected on the operation screen. Therefore, the operationality of the GUI screen is not lost, even in the case that the fraud screen theme including such a color attribute is downloaded.

In the present preferred embodiments, a fraud screen theme is rejected by mounting the following functions on a data processing apparatus.

(1) A check function of calculating the distance between colors of adjacent colors like a background color and a character color of a GUI control when a screen theme is given, and of rejecting the screen theme in the case that the distance between colors is smaller than a fixed value, is prepared.

(2) The above-mentioned check (1) is performed at the following times, and the use of a fraud screen theme is rejected.
At preparing a screen theme
At downloading a screen theme
At selecting a screen theme

It is conceivable that the check function of such a screen theme is mounted on the following places.
(a) Application that supports the preparation of a screen theme definition file (screen theme preparation tool)
(b) Server that offers the screen definition file (screen theme offering server)
(c) Terminal device that downloads the screen theme definition file from the server and uses it

If the check function is mounted on (a) and/or (b), the preparation of a fraud screen theme can be prevented. However, in the case where a fraud screen theme has been prepared nevertheless, the preparation can be rejected only by mounting the check function on the data processing apparatus such as a terminal device (c).

As the method of calculating a distance between colors, a method of simply calculating a three dimension Euclid distance between the RGB of a background color and that of a character color using the RGB that is three primary colors of light, is conceivable. A human being, however, recognizes the boundary of an image on the basis of the difference of brightness (lightness). Therefore, it is appropriate to use the brightness difference between a background color and a character color as a distance between colors.

FIG. 2 shows the configuration diagram of a portable terminal device (specifically, a portable cellphone) that is an example of the data processing apparatus provided with the above-mentioned check function. The portable terminal device of FIG. 2 comprises an antenna 201, a communication processing unit 202, a control unit 203, a storage unit 204, a speaker 205, a microphone 206, a display 207 and an operation unit 208 such as an operation button, etc.

The antenna 201 receives information from a radio network and transmits information to the radio network. The communication processing unit 202 performs the processing required for radio communications. The speaker 205 is used for the output of voice. The microphone 206 is used for the input of voice. The display 207 outputs output information such as operation screens, texts, images, etc. other than voice. The operation unit 208 is used for the input of the instructions from a user.

The storage unit 204 includes a flash memory (ROM (Read Only Memory)) and stores various kinds of application programs including a screen theme check program 211, the data of a screen theme definition file 212, etc. The control unit 203 includes a CPU (Central Processing Device) and a RAM (Random Access Memory), and controls the operations of a whole terminal using the program and data that are stored in the storage unit 204.

When a new screen theme definition file is downloaded from the radio network on the basis of the instructions from a user, the control unit 203 activates the screen theme check program 211 and checks whether or not the screen theme definition file is fraud. If the downloaded screen theme definition file is not fraud, the file is stored in the storage unit 204 as a screen theme definition file 212 and the present screen theme is changed to a new screen theme in accordance with the data in the file.

Furthermore, the screen theme check program 211 can be installed in a portable terminal through an optional computer-readable storage medium such as a memory card, a flexible disk, a CD-ROM (Compact Disk Read Only Memory), an optical disk, a magneto-optical disk, etc. The portable terminal device can download the screen theme check program 211 from external devices such as a server, etc. At this time, the external devices generate conveyance signals for conveying the screen theme check program 211 and transmit them to the portable terminal device through a transmission medium on the radio network.

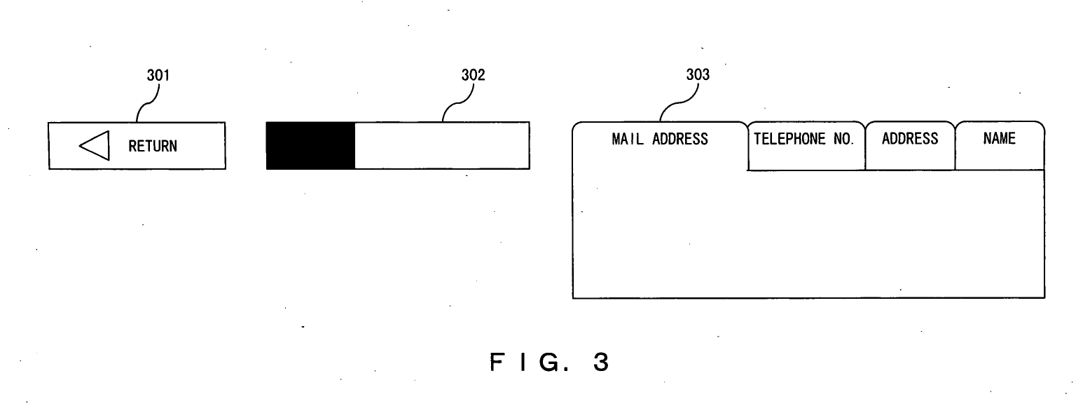

FIG. 3 shows one example of the GUI control that is displayed on a screen of the display 207 in accordance with the screen theme. A button (Button) 301 is used for specific operations to be instructed by a user. A progress bar (ProgressBar) 302 is used for notifying the progressing situation of a time-consuming process to a user. A tab (TAB) 303 is used for changing a plurality of screens in one window.

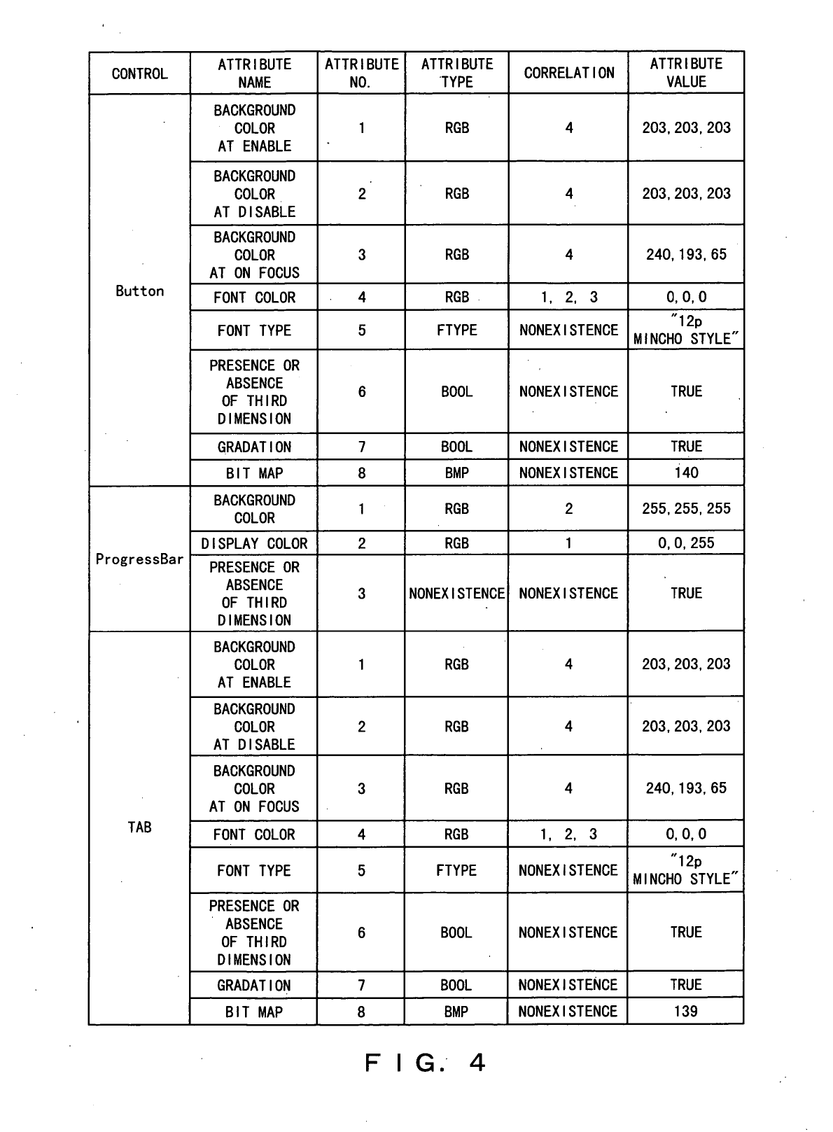

The screen theme definition file of the GUI screens that include these GUI controls further includes, for example, the data as shown in FIG. 4. In the screen theme definition file of FIG. 4, the name of each GUI control, the name of the attribute provided in each GUI control, the number, classification or type, correlation and attribute values of each attribute are recorded. The attribute number represents the identification information of an attribute while the attribute classification or type represents data classification of the attribute value.

For example, as a color attribute regarding the display color of a button, a background color at Enable, a background color at Disable, a background color at On Focus and a font color are defined. The classification of these attributes is represented by RGB and the value of RGB is recorded in the column of the corresponding attribute value as color information. The background color at Enable is the background color when the function of a button is effective. The background color at Disable is a background color when the function of a button is ineffective. The background color at On Focus is a background color when a user selects the area of a button using the operation unit 208. Moreover, a font color corresponds to the color of the character on a button.

The column of a correlation regarding one attribute represents the presence or absence of the other attribute having the correlation with the one attribute. If the correlation exists, the number of the other attribute is set in this column. The existence of the correlation between two attributes means the existence of some kind of restriction condition that is imposed on these attributes. For example, the character and background on a button are adjacent to each other on a display screen and the boundary between them should be recognized. Therefore, the correlation is set between a character color (font color) and a background color.

In the column of the correlation among a background color at Enable, a background color at Disable and a background color at On Focus of the button of FIG. 4, an attribute number “4” of the font color of the other attribute is recorded. In the column of the correlation of the font color, conversely, attribute numbers “1”, “2” and “3” of these three background colors are recorded.

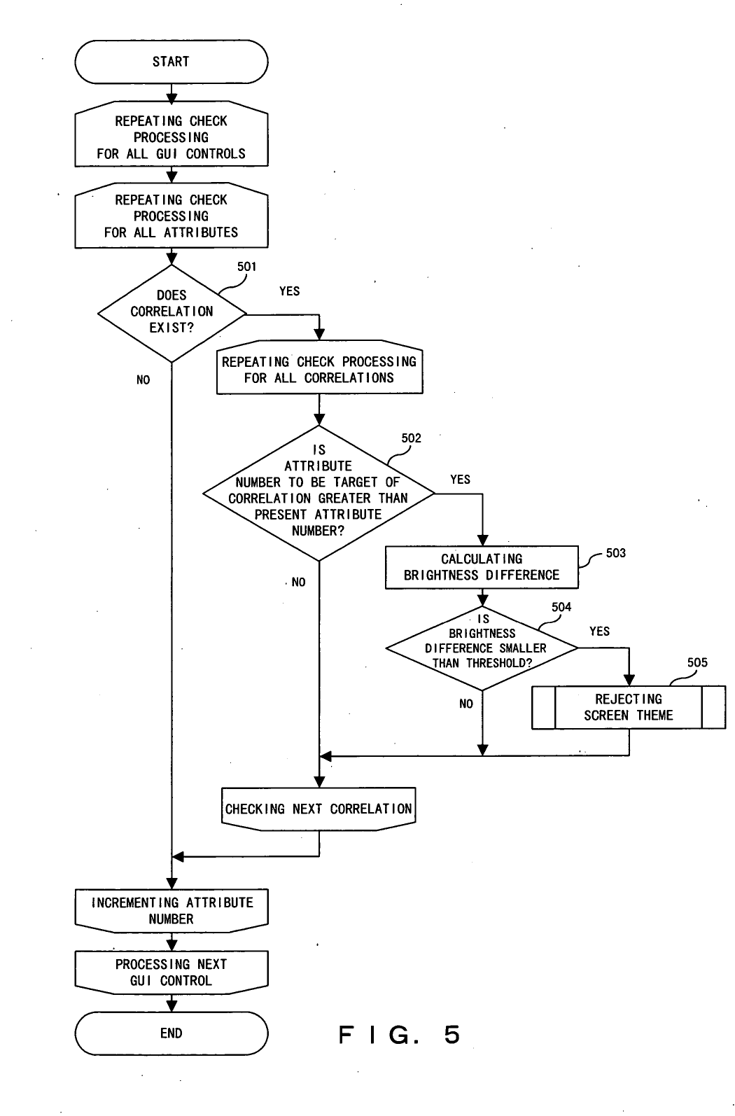

The following is the detailed explanation of processes that are carried out using the screen theme check program 211 of FIG. 2 in reference to FIGS. 5 to 7.

FIG. 5 is a flowchart of such a screen theme check processing. When the screen theme check program 211 is activated, the control unit 203 reads in the downloaded screen theme definition file and refers to the data of the first recorded GUI control. Then, the control unit 203 sets the present attribute number to “1”, refers to the data of the first attribute and checks whether or not the correlation is set (step 501).

If the correlation is set, the attribute number of the other attribute to be set first is picked up and the picked-up number is compared with the present attribute number (step 502). If the attribute number of the other attribute is greater than the present attribute number, the brightnesses of the two attributes are calculated and the difference between the obtained brightness values (brightness difference) is also obtained (step 503) Here, a brightness value Y that is experientially known is calculated from the value of RGB that is set as, an attribute value using the following equation.
Y=0.299R+0.587G+0.114B

Then, the brightness difference is compared with a predetermined threshold (step 504). If the brightness difference is smaller than the threshold, it is determined that the downloaded screen theme definition file is a fraud and the processing of rejecting the screen theme is carried out (step 505) If the brightness difference is equal to or greater than the threshold, the processing in step 505 is not performed.

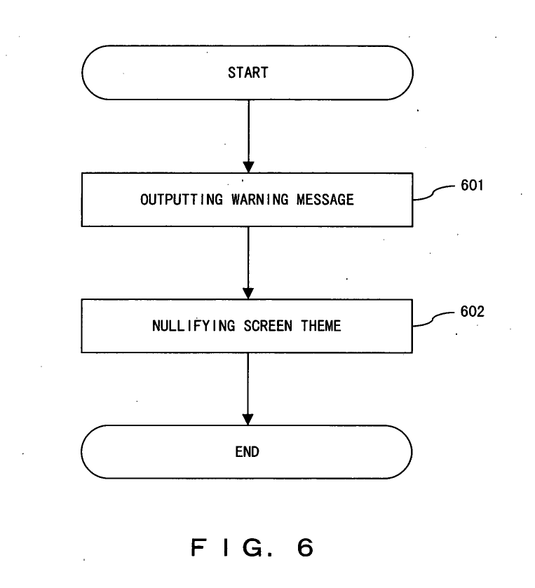

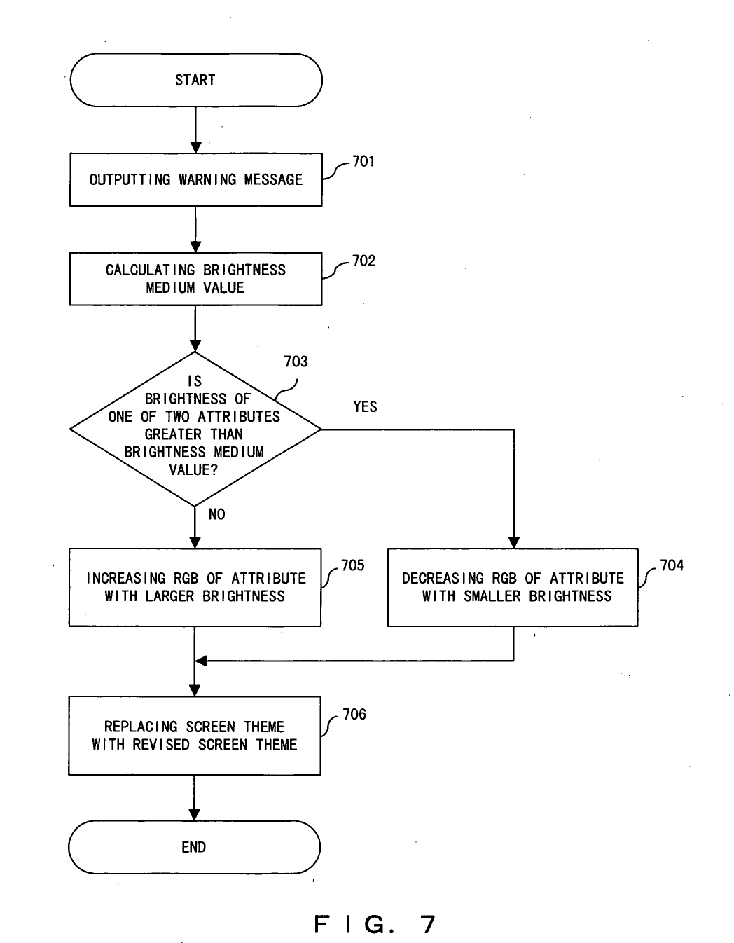

As a method of rejecting the screen theme in step 505, both a method of nullifying a downloaded screen theme definition file and a method of automatically revising and using a downloaded screen theme definition file so as to distinguish a character, are conceivable. In the case of the former processing, the screen theme nullification processing of FIG. 6 is carried out while in the case of the latter processing, the screen theme revision processing of FIG. 7 is carried out.

In the screen theme nullification processing of FIG. 6, the control unit 203 outputs from the display 207 or the speaker 205 (step 601) a warning message to notify to a user the fact that a fraud screen theme is downloaded. Then, the control unit 203 nullifies the downloaded screen theme definition file (step 602) and terminates the check processing of FIG. 5.

In the screen theme revision processing of FIG. 7, the control unit 203 outputs the warning message similar to that in step 601 of FIG. 6 (step 701) and calculates the medium value of brightness using the following equation (step 702).
Brightness medium value=(0.299*256+0.587*256+0.114*256)/2

Then, the brightnesses of two attributes that have correlation to each other are respectively compared with the brightness medium value. It is checked whether one of the brightnesses is greater than the brightness medium value or whether both brightnesses are equal to or smaller than the medium value (step 703). If one brightness is greater than the brightness medium value, the RGB value of the attribute with the smaller brightness is decreased (step 704). If both brightnesses are less than or equal to the brightness medium value, the RGB value of the attribute with the greater brightness is increased (step 705), thereby revising the screen theme definition file. Then, the downloaded screen theme definition file is replaced with the revised one (step 706) and the check processing of FIG. 5 is continued.

In the case where a check processing is continued after step 504 or 505 of FIG. 5, the control unit 203 checks whether or not the attribute number of another attribute is set in the correlation column. If such an attribute number is set, the processes in and after step 502 are repeated for another attribute. When the checks pertaining to all the other attributes terminate, the present attribute number is incremented by only 1 and the processes in and after step 501 are repeated for the next attribute. When the checks pertaining to all the attributes of the first GUI control terminate, the same processes are performed for the next GUI control.

When the checks pertaining to all the GUI controls of the downloaded screen theme definition file terminate in this way, the screen theme definition file is stored in the storage unit 204 and a new screen theme is set in the case where the screen theme is not rejected.

However, when it is determined that any brightness difference of any GUI control is smaller than the threshold, the character is deemed to be non-identifiable and the screen theme is rejected. At this time, if the screen theme definition file is nullified by the processing in FIG. 6, the present screen theme is ongoingly used. Therefore, the operationality of the GUI screen is not lost.

Moreover, if the screen theme definition file is revised by the processing of FIG. 7, the revised screen theme definition file is stored in the storage unit 204 when a check terminates and a new screen theme is set. In this case, too, the screen theme with an identifiable character is set so that the operationality of the GUI screen is not lost.

In the above-explained embodiment, the case that the check function of a screen theme is mounted on a portable terminal device is mainly explained. Furthermore, it is possible to mount the same check function on another terminal device such as the personal computer of a desktop. In the case that the check function is mounted on a screen theme preparation tool and a screen theme offer server, the same effect can be obtained.

1. A data processing apparatus, comprising:
a display device displaying an operation screen in accordance with a screen theme;
a check device checking a distance between colors of two color attributes out of color attributes of screen parts included in an inputted screen theme definition file, the two color attributes being adjacent to each other when the screen parts are displayed on the operation screen and rejecting use of the screen theme definition file in a case that the distance between colors is smaller than a threshold; and
a change device changing a screen theme of the operation screen to a screen theme designated by the screen theme definition file when use of the screen theme definition file is not rejected.

2. The data processing apparatus according to claim 1, wherein
the check device selects a character color and a background color of the screen part as the two adjacent color attributes.

3. The data processing apparatus according to claim 1, wherein
the check device calculates a difference between brightneses of the two adjacent color attributes as the distance between colors.

4. The data processing apparatus according to claim 1, wherein
the check device nullifies the screen theme definition file in a case that the distance between colors is smaller than the threshold.

5. The data processing apparatus according to claim 1, wherein:
the check device revises the screen theme definition file by changing color information of one of the two adjacent color attributes in a case that the distance between colors is smaller than the threshold; and
the change device changes a screen theme of the operation screen to a screen theme designated by the screen theme definition file in which a screen theme of the operation screen is revised.

6. A data processing apparatus, comprising:
a check device checking a distance between colors of two color attributes selected out of color attributes of screen parts included in an inputted screen theme definition file, the two color attributes being adjacent to each other when the screen parts are displayed on the operation screen, and rejecting use of the screen theme definition file in a case where the distance between colors is smaller than a threshold; and
a change device changing a screen theme of the operation screen to a screen theme designated by the screen theme definition file when use of the screen theme definition file is not rejected.

7. A storage medium storing a program for a data processing apparatus, wherein
the program directs the data processing apparatus to perform:
checking a distance between colors of two color attributes selected out of color attributes of screen parts included in an inputted screen theme definition file, the two color attributes being adjacent to each other when the screen parts are displayed on the operation screen; and
rejecting use of the screen theme definition file in a case that the distance between colors is smaller than a threshold.

8. A conveyance signal conveying a program for a data processing apparatus, wherein
the program directs the data processing apparatus to perform:
checking a distance between colors of two color attributes selected out of color attributes of screen parts included in an inputted screen theme definition file, the two color attributes being adjacent to each other when the screen parts are displayed on the operation screen; and
rejecting use of the screen theme definition file in a case where the distance between colors is smaller than a threshold.

9. A method of changing a screen theme for a data processing apparatus displaying an operation screen in accordance with a screen theme, performing:
checking a distance between colors of two color attributes out of color attributes of screen parts included in an inputted screen theme definition file, the two color attributes being adjacent to each other when the screen parts are displayed on the operation screen;
rejecting use of the screen theme definition file in a case that the distance between colors is smaller than a threshold; and
changing a screen theme of the operation screen to a screen theme designated by the screen theme definition file when use of the screen theme definition file is not rejected.

10. A data processing apparatus, comprising:
a check device checking a distance between colors of two color attributes out of color attributes of screen parts included in an inputted screen theme definition file, the two color attributes being adjacent to each other when the screen parts are displayed on the operation screen and rejecting use of the screen theme definition file in a case that the distance between colors is smaller than a threshold; and
a change device changing a screen theme of the operation screen to a screen theme designated by the screen theme definition file when use of the screen theme definition file is not rejected.
